(19) United States
(12) Patent Application Publication
(10) Pub. No.: US 2017/0257423 A1
(43) Pub. Date: Sep. 7, 2017

(54) METHOD OF AUTOMATICALLY DOWNLOADING VIDEO BASED ON A USER FLAG AND ELECTRONIC DEVICE

(71) Applicants: Le Holdings (Beijing) Co., Ltd., Beijing (CN); LeCloud Computing Co., Ltd., Beijing (CN)

(72) Inventor: Yong MA, Beijing (CN)

(21) Appl. No.: 15/245,106

(22) Filed: Aug. 23, 2016

Related U.S. Application Data
(63) Continuation of application No. PCT/CN2016/089139, filed on Jul. 7, 2016.

(30) Foreign Application Priority Data
Mar. 2, 2016 (CN) 201610118591.1

(51) Int. Cl. H04L 29/08

(52) U.S. Cl. CPC H04L 67/10; H04L 67/306

(57) ABSTRACT

A method of automatically downloading a video based on a user flag is disclosed. The method includes: acquiring video information of a video file that is flagged, storing the video information into a video flag table, and uploading the video flag table; receiving a table of updated video files, wherein the table of updated video files stores correspondence relationships between each flagged updated video file and updated video information therein; and extracting the updated video information and downloading the updated video file according to the updated video information.

### CROSS-REFERENCE TO RELATED APPLICATIONS

This application is a continuation of International Application No. PCT/CN2016/089139, filed on Jul. 7, 2016, which is based upon and claims priority to Chinese Patent Application No. 201610118591.1, filed on Mar. 2, 2016, the entire contents of all of which are incorporated herein by reference.

### TECHNICAL FIELD

The present disclosure relates to the field of communication technologies, and particularly, to a method for automatically downloading a video based on a user flag and an electronic device.

### BACKGROUND

With the advancement of the computer communication technologies, the Internet technologies and the multimedia technologies, watching video has become more and more popular. Currently, the needs for people browsing and watching video become increasingly higher, but in many cases (i.e., during the commuter time, in the outdoor environment and etc) there is no satisfactory network condition available for satisfying people's needs. Additionally, other reasons such as high network communication fees or instable network signals also prevent the users from browsing and watching videos.

A solution adopted in related arts is as follows: the user logs into a multimedia platform and, when the network condition is satisfactory, self operates to buffer a video for browsing and watching later.

### SUMMARY

An embodiment of the present disclosure provides a method of automatically downloading a video based on a user flag. The method includes the following steps:

at a terminal:

acquiring video information of a video file that is flagged;

storing the video information into a video flag table;

uploading the video flag table;

receiving a table of updated video files, wherein the table of updated video files stores correspondence relationships between each flagged updated video file and updated video information therein;

extracting the updated video information; and

downloading the updated video file according to the updated video information.

In another aspect, another embodiment of the present disclosure also provides an electronic device. The electronic device includes:

at least one processor; and

a memory communicably connected with the at least one processor for storing instructions executable by the at least one processor, wherein execution of the instructions by the at least one processor causes the at least one processor to:

acquire video information of a video file that is flagged;

store the video information into a video flag table;

upload the video flag table;

receive a table of updated video files, wherein the table of updated video files stores correspondence relationships between each flagged updated video file and updated video information therein;

extract the updated video information; and

download the updated video file according to the updated video information.

Still another embodiment of the present disclosure provides a non-transitory computer-readable storage medium. The non-transitory computer-readable storage medium stores executable instructions, wherein when the executable instructions are executed by an electronic device, causes the electronic device to:

acquire video information of a video file that is flagged;

store the video information into a video flag table;

upload the video flag table;

receive a table of updated video files, wherein the table of updated video files stores correspondence relationships between each flagged updated video file and updated video information therein;

extract the updated video information; and

download the updated video file according to the updated video information.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart diagram of a method of automatically downloading a video based on a user flag according to an embodiment of the present disclosure.

FIG. 2 is a schematic flowchart diagram of a method of automatically downloading a video based on a user flag according to another embodiment of the present disclosure.

FIG. 3 is a schematic flowchart diagram of an apparatus of automatically downloading a video based on a user flag according to an embodiment of the present disclosure.

FIG. 4 is a schematic flowchart diagram of an apparatus of automatically downloading a video based on a user flag according to another embodiment of the present disclosure.

### DETAILED DESCRIPTION

To make the objective, technical solutions and advantages of the present disclosure clearer, the present disclosure will be further detailed with reference to embodiments thereof and the attached drawings.

In the current state of multimedia platforms, the user logging into a multimedia platform can only check on his own if there is any update for a video file in which he is interested, and if there is an update, manually buffers the update. This leads to very poor user experiences. To solve this problem, an embodiment of the present disclosure is intended to satisfy the user's demand for automatically downloading updates of a video file in which the user is interested. Accordingly, the idea of an embodiment of the present disclosure is to fulfill the function of automatically downloading updates.

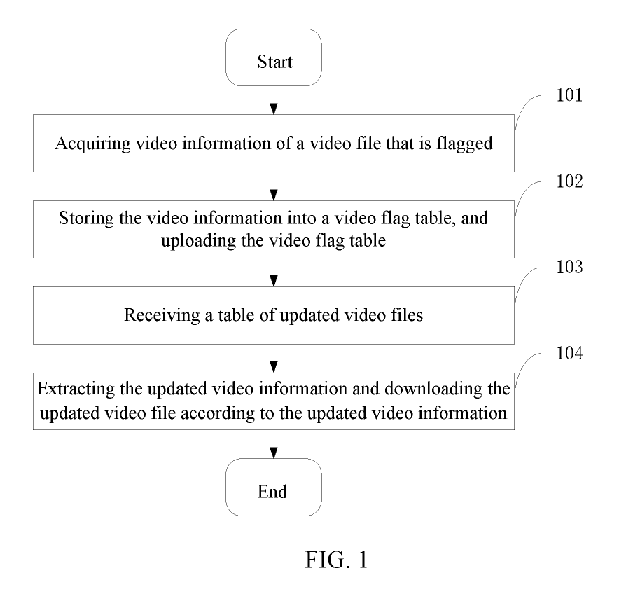

Referring to FIG. 1, there is shown a schematic flowchart diagram of a method of automatically downloading a video based on a user flag according to an embodiment of the present disclosure. The method of automatically downloading a video based on a user flag is applied to a terminal, and specifically includes the following steps:

Step 101: acquiring video information of a video file that is flagged.

In some embodiments, the user may flag a video file in which he is interested so as to acquire video information of the video file that is flagged.

Step 102: storing the video information into a video flag table, and uploading the video flag table.

Here, the video flag table that is preset stores video information of all video files that are flagged. In some embodiments, the video flag table may be uploaded to a server periodically or in real time.

Step 103: receiving a table of updated video files.

In some embodiments, the video flag table uploaded in the step 102 may be received at the server side, and when it is monitored that there is an updated video file corresponding to the video information in the video flag table, the updated video information is stored into the table of updated video files. Then, the table of updated video files is pushed to a terminal in real time or periodically. Thereby, the table of updated video files can be received by the terminal (i.e., the step 103). The table of updated video files stores correspondence relationships between each flagged updated video file and updated video information therein. Additionally, the updated video information may include one or a combination of the name, the version number, the lead role, the publication time, the download address or the like of the updated video file.

Step 104: extracting the updated video information and downloading the updated video file according to the updated video information.

In an embodiment, after the table of updated video files is received, a network monitoring process needs to be activated so that when it is monitored that the network of the terminal is in a non-mobile data network state, updated video information is extracted and the updated video file is downloaded according to the updated video information. In this way, the automatic video pushing method described in some embodiments of the present disclosure can automatically recognize satisfactory network conditions and start the download process under the satisfactory network conditions. In another embodiment, after the updated video file is downloaded according to the updated video information, a memory monitoring process may also be activated so that when it is monitored that a utilization ratio of an available memory of the terminal is greater than a preset utilization ratio, the download is paused, and otherwise, the download is continued. In this way, an embodiment of the present disclosure can download the updated video file without affecting use of the terminal. This saves the terminal resources and greatly improves the usage effect of the terminal.

As an embodiment, after the table of updated video files is received, a power level of the terminal may be acquired. Then, it is determined whether the power level is lower than a preset power level threshold. If the power level is not lower than the preset power level threshold, then updated video information is extracted and updated video file is downloaded according to the updated video information. If the power level is lower than the preset power level threshold, then the updated video file is not downloaded. Accordingly, in some embodiments, the power level of the terminal can be acquired so that it is determined whether the power level is lower than the preset power level threshold, and only when the power level is not lower than the preset power level threshold, will updated video file be downloaded according to the updated video information. Thereby, this ensures that the updated video file is downloaded in a normal operation state of the terminal.

Additionally, in the process of downloading the updated video file according to the updated video information, the power level of the terminal is monitored, and if it is monitored that the power level of the terminal is lower than the preset power level threshold, then a progress of downloading the video file is acquired and it is determined whether the progress exceeds a preset progress threshold. If the progress exceeds the preset progress threshold, then the download is continued, and otherwise, the download is paused. Accordingly, an embodiment of the present disclosure can also monitor the power level of the terminal in real time in the process of downloading the video file, and if it is found that the power level of the terminal is lower than the power level threshold, it means that continuing to download the video file would affect normal operation of the terminal, so the download must be paused. Meanwhile, an embodiment of the present disclosure is designed in such a more humanized way that, when the power level of the terminal is lower than the power level threshold, the progress of downloading the video file is firstly acquired to determine whether the progress exceeds the preset progress threshold (i.e., whether download of the updated video file is about to be completed), and if the progress exceeds the preset progress threshold (i.e., download of the updated video file is about to be completed soon), then the download will be continued. In this way, the automatic downloading becomes more intelligent, and this improves the user experiences.

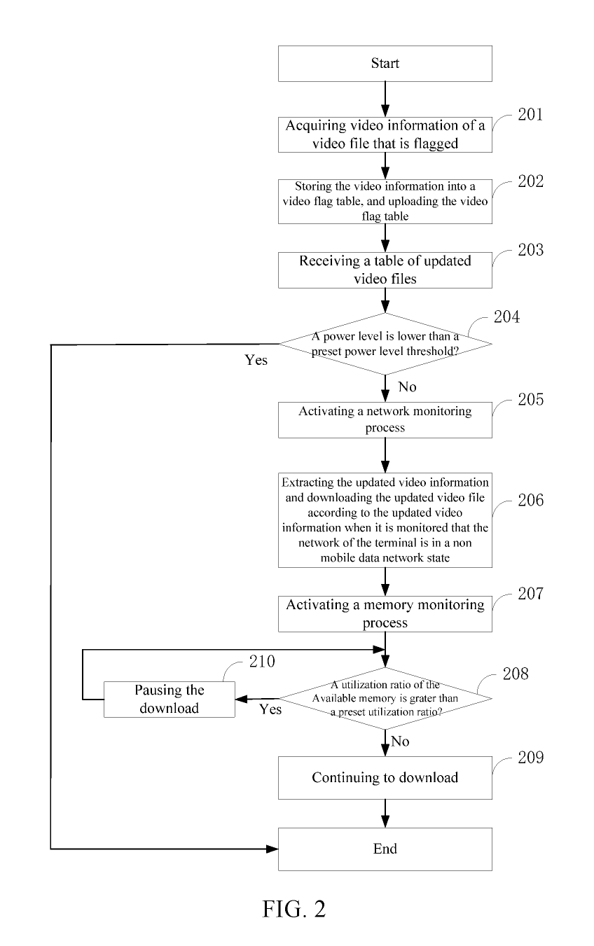

As an embodiment, as shown in FIG. 2, the method of automatically downloading a video based on a user flag may adopt the following steps:

Step 201: acquiring video information of the video file that is flagged.

Step 202: storing the video information into a video flag table, and uploading the video flag table.

Step 203: receiving a table of updated video files.

Step 204: acquiring a power level of the terminal, and determining whether the power level is lower than a preset power level threshold, and if the power level is not lower than the power level threshold, then the step 205 continues, and otherwise, the process is ended.

Step 205: activating a network monitoring process.

Step 206: extracting the updated video information and downloading the updated video file according to the updated video information when it is monitored that the network of the terminal is in a non mobile data network state.

Step 207: activating a memory monitoring process.

Step 208: determining whether a utilization ratio of an available memory of the terminal is greater than a preset utilization ratio. If the determination result is yes, then the process proceeds to the step 210, and otherwise, the process proceeds to the step 209.

Step 209: continuing to download.

Step 210: pausing the download and returning to the step 208.

As another embodiment, the power level of the terminal may be monitored in the process of downloading the updated video file according to the updated video information. If it is monitored that the power level of the terminal is lower than a preset power level threshold, then the progress of downloading the video file is acquired and it is determined whether the progress exceeds a preset progress threshold. If the progress exceeds the preset progress, then the download of the video file continues and otherwise, the download of the video file is paused. In other words, during the process of downloading the updated video file according to the updated video information, the progress of downloading exceeding the preset progress threshold means that the download is about to be completed soon and, therefore, the download is allowed to be completed. On the other hand, the progress of downloading not exceeding the preset progress threshold means that there is still a period of time to take before the download is completed and, therefore, the download will be paused. Thereby, this technical solution optimizes the process of downloading the video file and is of greater utility.

In another aspect of an embodiment of the present disclosure, an apparatus of automatically downloading a video based on a user flag is also provided. As shown in FIG. 3, the apparatus 300 of automatically downloading a video based on a user flag includes an update triggering unit 301, an update acquiring unit 302 and an update executing unit 303 connected in sequence. The update triggering unit is configured to acquire video information of a video file that is flagged, store the video information into a video flag table, and upload the video flag table. The update acquiring unit 302 is configured to receive a table of updated video files, wherein the table of updated video files stores correspondence relationships between each flagged updated video file and updated video information therein. The update executing unit 303 is configured to extract the updated video information and download the updated video file according to the updated video information.

In an embodiment, after receiving the table of updated video files, the update executing unit 303 needs to activate a network monitoring process so that when it is monitored that the network of the terminal is in a non-mobile data network state, the updated video information is extracted and the updated video file is downloaded according to the updated video information. In another embodiment of the present disclosure, after downloading the updated video file according to the updated video information, the update executing unit 303 may activate a memory monitoring process so that when it is monitored that a utilization ratio of an available memory of the terminal is greater than a preset utilization ratio, the download is paused, and otherwise, the download is continued.

As another embodiment of the present disclosure, after receiving the table of updated video files, the update executing unit 303 may acquire a power level of the terminal. Then, it is determined whether the power level is lower than a preset power level threshold, and if the power level is not lower than the preset power level threshold, then updated video information is extracted and updated video file is downloaded according to the updated video information. If the power level is lower than the preset power level threshold, then the updated video file is not downloaded. After downloading the updated video file according to the updated video information, the update executing unit 303 may monitor the power level of the terminal, and if it is monitored that the power level of the terminal is lower than the preset power level threshold, acquire a progress of downloading the video file and determine whether the progress exceeds a preset progress threshold, and if the progress exceeds the preset progress threshold, then the download is continued, and otherwise, the download is paused.

It shall be appreciated that, detailed implementations of the apparatus 300 of automatically downloading a video based on a user flag have been detailed in the aforesaid method of automatically downloading a video based on a user flag, so they will not be described herein again.

In summary, the method and the apparatus of automatically downloading a video based on a user flag provided in some embodiments of the present disclosure creatively solve the problem with the prior art that the video file can only be downloaded manually; and meanwhile, it is ensured that all favorite video file contents used by the user are up to date, thus giving better experiences; in this way, contents in which the user is interested are pushed to the user and downloaded directly without the need of user intervention; this has a broad and significant sense for promotion; and finally, the method and the apparatus of automatically downloading a video based on a user flag are compact and easy to control.

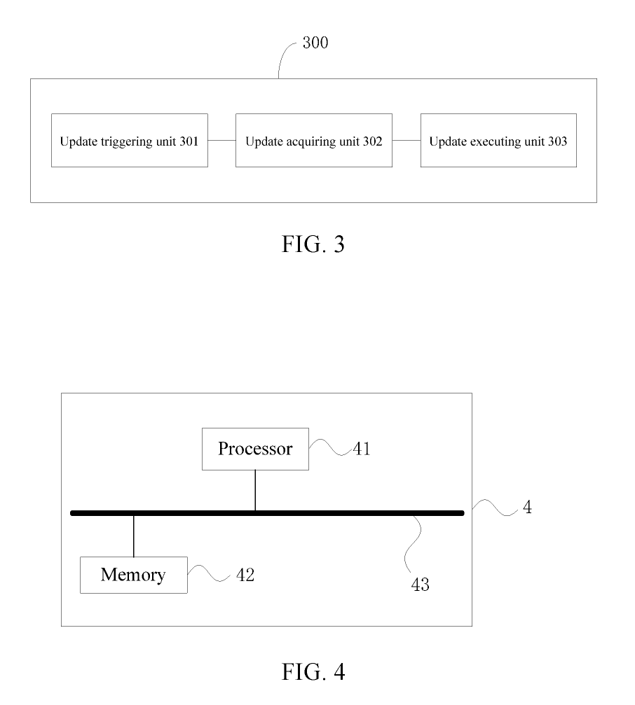

Referring to FIG. 4, FIG. 4 is another embodiment of an apparatus 40 of automatically downloading a video based on a user flag provided in the present disclosure. The apparatus 40 of automatically downloading a video based on a user flag includes: a processor 41, a memory 42, and a bus system 43. The processor 41 and the memory 42 are connected to each other via the bus system 43. The memory 42 is configured to store program instructions, and the processor 41 is configured to execute the program instructions stored in the memory 42, and the processor 41 is configured to:

acquire video information of a video file that is flagged, store the video information into a video flag table, and upload the video flag table;

receive a table of updated video files, wherein the table of updated video files stores correspondence relationships between each flagged updated video file and updated video information therein; and

extract the updated video information and download the updated video file according to the updated video information.

The memory 42 may be a non-transitory computed readable storage medium, which is configured to store computed executable program instructions. When the program instructions are executed by one or more central processors, for example, the processor 41 may be caused to perform the steps in the above mentioned embodiments of the method, for example, steps 101 to 104 illustrated in FIG. 1, steps 201 to 210 illustrated in FIG. 2. Or, the processor 41 may be caused to perform the modules in the above mentioned embodiments of the apparatus, for example, modules 301 to 303 illustrated in FIG. 3. The computed executable program instructions may also be stored and/or transmitted in any non-transitory computed readable storage medium, such that these program instructions are used by an instruction executing system, apparatus or device, or used in combination with the instruction executing system, apparatus or device. The instruction executing system, apparatus or device may be, for example, a computer-based system, a system including a processor or another system capable of acquiring program instructions from the instruction executing system, apparatus or device and executing the program instructions. For the purpose of this specification, the “non-transitory computed readable storage medium” may be any tangible medium including or storing computed executable program instructions. The computed executable program instructions may be used by the instruction executing system, apparatus or device, or used in combination with the executing system, apparatus or device. The non-transitory computed readable storage medium may include, but not limited to, a magnetic, optical and/or semiconductor memory. Examples of these memories include a magnetic disk, an optical disc based on CD, DVD and Blu-ray technology, and permanent solid memory (for example, a flash memory, a solid driver and the like).

It should be understood that in some embodiments of the present application, the processor 41 may be a central processing unit (CPU). The processor 41 may be a general processor, a digital signal processor (DSP), an application specific integrated circuit (ASIC), a field programmable gate array (FPGA) or another programmable logic device, a discrete gate or transistor logic device, or a discrete hardware component. The general processor may be a microprocessor or any customary processor or the like.

In addition to a data bus, the bus system 43 may include a power bus, a control bus, a state signal bus and the like. However, for clarity of description, various buses are all marked as the bus system 43.

In some embodiments of the present disclosure, the apparatus 40 of automatically downloading a video based on a user flag is not limited to the components and configurations as illustrated in FIG. 4, but may includes other or additional components having a plurality of configurations.

During the implementation, various steps in the above method and various modules or units in the above apparatus may be implemented by means of an integrated logic circuit in the processor 41 or by means of software. The steps in the method and modules or the units in the apparatus disclosed in some embodiments of the present disclosure may be directly embodied as being implemented by a hardware processor, or implemented by a combination of hardware in the processor and other software modules. The software module may be located in a random memory, a flash memory, a read-only memory, a programmable read-only memory, an electrically erasable programmable memory, a register or the like storage medium commonly known in the art. The storage medium is located in the memory 42. The processor 41 reads the information stored in the memory 42 and performs the steps of the above method in combination with the hardware thereof. For brevity of description, the details are not given herein any further.

Acquire video information of a video file that is flagged, store the video information into a video flag table, and upload the video flag table; receive a table of updated video files; and extract the updated video information and download the updated video file according to the updated video information. In this way, embodiments of the present disclosure can acquire video information of a video file flagged by the user, store the video information into a video flag table and upload the video flag table. Then when there is an updated video file corresponding to the video information in the video flag table, a table of updated video files can be automatically received, thus achieving the purpose of automatically downloading updated information in the table of updated video files.

As shall be appreciated by those of ordinary skill in the art, the above discussion of any embodiments is only illustrative and is not intended to imply that the scope (including the claims) of the present disclosure is limited to these examples; and within the spirits of the present disclosure, technical features of the above embodiments or different embodiments may be combined with each other, the steps may be achieved in any sequence, and there are many other variations in different aspects of the present disclosure described above, although they are not detailed for purpose of simplicity.

Additionally, for simplicity of the description and discussion and to prevent that the present disclosure is difficult to understand, publicly known power supply connections/ground connections with integrated circuits (ICs) and other parts may be or may not be shown in the attached drawings. Furthermore, the apparatus may be shown in the form of a block diagram to prevent that the present disclosure is difficult to understand and out of consideration of the following facts: details of implementations of the blocks are highly dependent on the platform on which the present disclosure is to be embodied (i.e., the details shall be completely within the scope understandable by those skilled in the art). While specific details (e.g., circuits) have been described to illustrate exemplary embodiments of the present disclosure, it shall be apparent to those skilled in the art that, the present disclosure may be embodied without these specific details or with variations of the specific details. Therefore, the description shall be considered to be illustrative rather than in a limiting sense.

Although the present disclosure has been described with reference to embodiments thereof, many replacements, modifications and variants of these embodiments will be apparent to those of ordinary skill in the art upon reviewing the above description. For example, other memory architectures (e.g., dynamic RAM (DRAM) may also utilize the discussed embodiments.

Embodiments of the present disclosure are intended to cover all such replacements, modifications and variations falling within the broad scope of the attached claims. Accordingly, any omissions, modifications, equivalent replacements, and alterations within the spirits and principles of the present disclosure shall be included in the scope of the present disclosure.

What is claimed is:

1. A method of automatically downloading a video based on a user flag, comprising:
at a terminal:
acquiring video information of a video file that is flagged;
storing the video information into a video flag table;
uploading the video flag table;
receiving a table of updated video files, wherein the table of updated video files stores correspondence relationships between each flagged updated video file and updated video information therein;
extracting the updated video information; and
downloading the updated video file according to the updated video information.

2. The method according to claim 1, after the receiving a video file update table comprising:
activating a network monitoring process so that when it is monitored that the network of a terminal is in a non-mobile data network state, the updated video information is extracted and the updated video file is downloaded according to the updated video information.

3. The method according to claim 2, after the downloading the updated video file according to the updated video information, comprising:
activating a memory monitoring process so that when it is monitored that a utilization ratio of an available memory of the terminal is greater than a preset utilization ratio, the download is paused, and otherwise, the download is continued.

4. The method according to claim 1, the after the receiving a table of updated video files, comprising:
acquiring a power level of the terminal;
determining whether the power level is lower than a preset power level threshold, and extracting updated video information and downloading updated video file according to the updated video information if the power level is not lower than the preset power level threshold, and, doing nothing if the power level is lower than the preset power level threshold.

5. The method according to claim 4, after the downloading the updated video file according to the updated video information, comprising:
monitoring the power level of the terminal, and acquiring a progress of downloading the video file and determining whether the progress exceeds a preset progress threshold if it is monitored that the power level of the terminal is lower than the preset power level threshold, continuing to download the video file if the progress exceeds the preset progress threshold, and pausing the download otherwise.

6. An electronic device, comprising:
at least one processor; and
a memory communicably connected with the at least one processor for storing instructions executable by the at least one processor, wherein execution of the instructions by the at least one processor causes the at least one processor to:
acquire video information of a video file that is flagged;
store the video information into a video flag table;
upload the video flag table;
receive a table of updated video files, wherein the table of updated video files stores correspondence relationships between each flagged updated video file and updated video information therein;
extract the updated video information; and
download the updated video file according to the updated video information.

7. The electronic device according to claim 6, wherein after the receiving a table of updated video files, execution of the instructions by the at least one processor causes the at least one processor to:
activate a network monitoring process so that when it is monitored that the network of a terminal is in a non-mobile data network state, the updated video information is extracted and the updated video file is downloaded according to the updated video information.

8. The electronic device according to claim 7, wherein after the downloading the updated video file according to the updated video information, execution of the instructions by the at least one processor causes the at least one processor to:
activate a memory monitoring process so that when it is monitored that a utilization ratio of an available memory of the terminal is greater than a preset utilization ratio, the download is paused, and otherwise, the download is continued.

9. The electronic device according to claim 6, wherein after the receiving a table of updated video files, execution of the instructions by the at least one processor causes the at least one processor to:
acquire a power level of the terminal;
determine whether the power level is lower than a preset power level threshold, and extract updated video information and download updated video file according to the updated video information if the power level is not lower than the preset power level threshold; and do nothing if the power level is lower than the preset power level threshold.

10. The electronic device according to claim 9, wherein after the downloading the updated video file according to the updated video information, execution of the instructions by the at least one processor causes the at least one processor to:
monitor the power level of the terminal, and acquire a progress of downloading the video file and determine whether the progress exceeds a preset progress threshold if it is monitored that the power level of the terminal is lower than the preset power level threshold, and continue to download the video file if the progress exceeds the preset progress threshold, and pause the download otherwise.

11. A non-transitory computer-readable storage medium storing executable instructions, wherein when executed by an electronic device, causes the electronic device to:
acquire video information of a video file that is flagged;
store the video information into a video flag table;
upload the video flag table;
receive a table of updated video files, wherein the table of updated video files stores correspondence relationships between each flagged updated video file and updated video information therein;
extract the updated video information; and
download the updated video file according to the updated video information.

12. The non-transitory computer-readable storage medium according to claim 11, wherein after the receiving a table of updated video files, when the executable instructions is executed by the electronic device, causes the electronic device to:
activate a network monitoring process so that when it is monitored that the network of a terminal is in a non-mobile data network state, the updated video information is extracted and the updated video file is downloaded according to the updated video information.

13. The non-transitory computer-readable storage medium according to claim 12, wherein after the downloading the updated video file according to the updated video information, when the executable instructions is executed by the electronic device, causes the electronic device to:
activate a memory monitoring process so that when it is monitored that a utilization ratio of an available memory of the terminal is greater than a preset utilization ratio, the download is paused, and otherwise, the download is continued.

14. The non-transitory computer-readable storage medium according to claim 11, wherein after the receiving a table of updated video files, when the executable instructions is executed by the electronic device, causes the electronic device to:
acquire a power level of the terminal;
determine whether the power level is lower than a preset power level threshold, and extract updated video information and download updated video file according to the updated video information if the power level is not lower than the preset power level threshold; and
do nothing if the power level is lower than the preset power level threshold.

15. The non-transitory computer-readable storage medium according to claim 14, wherein after the downloading the updated video file according to the updated video information, when the executable instructions is executed by the electronic device, causes the electronic device to:
monitor the power level of the terminal, and acquire a progress of downloading the video file and determine whether the progress exceeds a preset progress threshold if it is monitored that the power level of the terminal is lower than the preset power level threshold, and continue to download the video file if the progress exceeds the preset progress threshold, and pause the download otherwise.
